(19) United States
(12) Patent Application Publication
(10) Pub. No.: US 2010/0117264 A1
(43) Pub. Date: May 13, 2010

(54) COMPRESSION MOULDING METHOD FOR COMPOSITES, AND MOULD DEVICE FOR IMPLEMENTATION THEREOF

(75) Inventor: Guy Valembois, Toulouse (FR)

Correspondence Address: EGBERT LAW OFFICES, 412 MAIN STREET, 7TH FLOOR, HOUSTON, TX, 77002, US

(73) Assignee: EA TECHNIQUE (Societe par actions simplifiee), L ' Isle Jourdain (FR)

(21) Appl. No.: 12/596,646

(22) PCT Filed: Apr. 30, 2008
(86) PCT No.: PCT/FR08/50780

§ 371 Date: Jan. 22, 2010

(30) Foreign Application Priority Data
Apr. 30, 2007 (FR) 0754803

(51) Int. Cl. B29C 43/52

(52) U.S. Cl. 264/319; 425/125

(57) ABSTRACT

Compression molding method for composites including the step of forming a dough under pressure, including an amalgam of non-woven fibers randomly mixed and associated, in a defined proportion, with a thermosetting or thermoplastic material. The preparation of the dough includes mixing the fibers and the thermosetting or thermoplastic material, in a vacuum, while the forming operation is carried out by introducing the dough into a mould shaped and dimensioned to withstand high pressures. There is a molding cavity in the form of a part to be produced and provided with at least one well configured so as to accommodate, tightly, a plunger piston, which, by sliding, can pressurize the dough in the cavity, and therefore form the latter in the mould.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention is related to the field of the manufacture by molding of objects made of thermoplastic or thermosetting composite material.

This invention relates to a method for the compression molding of composite materials, as well as to the mold device permitting the implementation of this method.

2. Description of Related Art Including Information Disclosed Under 37 CFR 1.97 and 37 CFR 1.98

Many molding methods for composite materials are known, which consist of forming under pressure an amalgam of elements of composite material generally formed of non-woven webs or web pieces of reinforcing fibers embedded in a thermosetting or thermoplastic matrix. The fibers are of different types, such as for example glass, carbon or aramid fibers, while the matrix is of the epoxide or phenolic type.

Thus, from FR 2,740,149, there is a known method for producing a sheet-like molding material permitting to manufacture a toe-protecting shell for safety shoes. The method consists of cutting into patches or pieces a fabric in which the fibers are arranged unidirectionally or are woven.

From JP 02 131929, there are also known a method and a device for manufacturing a reinforced plastic article, said method consisting of superimposing in a mold several layers of material to be molded, among which one layer of colored tetrafluorethylene resin.

EP 916 477 provides cutting a web of fibers embedded in a matrix into a multiplicity of elements, then arranging tri-dimensionally said elements, then carrying out the compression molding of the obtained tri-dimensional arrangement.

Also EP0376472 is known, which relates to a thermoplastic composite plate including a thermoplastic resin and pieces formed by means of single-directionally oriented reinforcing fibers.

All these documents, and others, essentially relate to methods for manufacturing parts having generally a substantially constant thickness, in order to manufacture for example shells or plates. However, none of them relates to the manufacture of more bulky parts, namely because of the difficulty of the implementation of large-volume shape while guaranteeing the mechanical properties of the part.

### BRIEF SUMMARY OF THE INVENTION

This invention is aimed at coping with this shortcoming by providing a method for manufacturing parts of composite materials of varying shapes and thicknesses while guaranteeing the cohesion of the material and, hence, its mechanical properties. The method according to the invention is aimed at achieving a molded part that can have a sufficient isotropy providing it a machinability comparable to that of a metallic foundry part.

The method for compression molding of composite materials according to the invention consists of forming, under pressure, a dough formed of an amalgam of non-woven fibers, randomly mixed and associated, according to a determined proportion, with a thermosetting or thermoplastic material. It is essentially characterized in that the preparation of said dough consists of mixing said fibers and said thermosetting or thermoplastic material under air vacuum, while said forming is achieved by inserting said dough into a mold designed and dimensioned so as to withstand high pressures, and which has a molding cavity having the shape of the part to be made and provided with at least one well configured so as to tightly receive a plunger piston the sliding of which is capable of bringing about the putting under pressure of said dough in said cavity and, hence, of forming the latter in said mold.

According to an additional feature of the molding method according to the invention, during the preparation of the dough, the fibers are placed under air vacuum, then the resin is incorporated therein using the suction effect created by the air vacuum.

According to an additional feature of the molding method according to the invention, the fibers and the thermosetting or thermoplastic material are mixed, after having previously incorporated a volatile dissolvent.

The often rather high viscosity of the resin makes it difficult to properly and homogeneously mix the viscous and fibrous dough. The incorporation of a dissolvent with volatile properties to the thermosetting or thermoplastic material makes the latter less viscous, so that the process of mixing the fibers and the resin is more performing and permits to achieve a homogenous dough. At the end of the mixing, the volatile compound dissipates through evaporation, this phase of disappearing of the dissolvent being accelerated when the mixing is performed under air vacuum.

According to another additional feature of the molding method according to the invention, the fibers and the thermosetting or thermoplastic material are mixed while complying with the following rules, the ratio between the length, or the minimum characteristic thickness, of the part to be manufactured, and the maximum length of the fibers is higher than 2, preferably equal to 4, and the ratio between the minimum length of the fibers and the diameter of the fibers is higher than 10.

According to an additional feature of the molding method according to the invention, when the mold includes several wells and plunger pistons, said pistons are activated simultaneously or separately according to a particular time sequence.

According to another additional feature of the molding method according to the invention, the material is subjected, before, during and/or after the putting under pressure, to particular temperature conditions.

According to another additional feature of the molding method according to the invention, a force is applied to the plunger piston or pistons, so as to generate a pressure between 30 and 1000 bars, according to the needs.

According to another additional feature of the molding method according to the invention, fibers having a length that can vary in a controlled or random way between 0.1 and 100 mm are used for forming the dough.

According to another additional feature of the molding method according to the invention, prior to the insertion of the dough, one or several layers of woven or non-woven web of reinforcing fibers embedded in a thermosetting or thermoplastic matrix are placed in the molding cavity of the mold.

According to another additional feature of the molding method according to the invention, one or several inserts are incorporated into the dough, aimed at remaining in the part to be made, this incorporation occurring either during the preparation of said dough or after the insertion of said dough into the mold, or during the insertion into said mold, said insert or inserts having previously been positioned in the latter.

According to another additional feature of the molding method according to the invention, the insert or inserts consist of one or several metallic or plastic elements, or of one or several composite elements being in the form of a braid and/or a web or a layer of composite material.

According to another additional feature of the molding method according to the invention, the materials entering into the composition of the dough are finely weighed, so as to guarantee the shape of the part to be molded.

According to another additional feature of the molding method according to the invention, more thermosetting or thermoplastic material than necessary is incorporated into the dough, and the flow and evacuation of the excess of said material is foreseen.

According to another additional feature of the molding method according to the invention, at least one element made of compressible material is incorporated into the dough.

This invention also relates to a mold device for implementing the molding method according to the invention.

The mold device according to the invention is essentially characterized in that it is formed of one element or several assembled elements having internally a cavity having the shape of the part to be made. It comprises at least one well designed, on the one hand, for permitting the loading of the mold with material to be molded and, on the other hand, for slideably receiving, tightly, a plunger piston the sliding of which generated by driving means is capable of bringing about the putting under pressure of said material to be molded.

According to an additional feature of the mold device according to the invention, the plunger piston has, on the inner side of the mold, an end shaped so as to participate in the forming of the part to be molded.

The advantages and features of the method and the device according to the invention will become clear from the following description that refers to the attached drawing, which represents several non-restrictive embodiments of same.

### BRIEF DESCRIPTION OF THE SEVERAL VIEWS OF THE DRAWINGS

FIGS. 1a and 1b represent schematic views of a mold device for implementing the molding method according to the invention and illustrating two phases of this method.

FIGS. 2a, 2b and 2c represent schematic views of a variant of the mold device for implementing the molding method according to the invention.

FIGS. 3a, 3b and 3c represent schematic views of another variant of the mold device for implementing the molding method according to the invention.

### DETAILED DESCRIPTION OF THE INVENTION

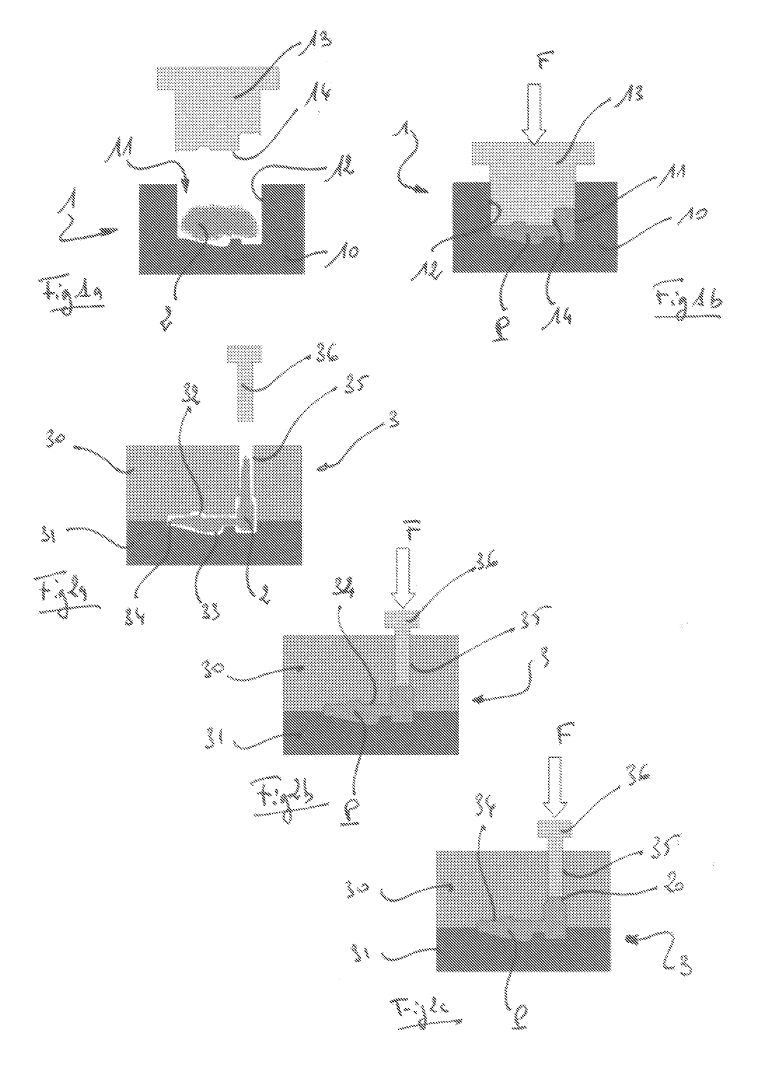

When referring to FIGS. 1a and 1b, one can see a mold device 1 according to the invention, which comprises an element 10, in which a cavity 11 having the shape of the part P to be molded is provided for. The mold 1 also comprises a well 12 ending in the cavity 11, and in which a plunger piston 13 can tightly slide under the action of driving means, not shown.

According to the inventive method, a dough 2 formed of an amalgam of non-woven fibers randomly mixed and associated in a determined proportion with a thermosetting or thermoplastic material is prepared.

The fibers can be of different types, they can, non-restrictively, consist of glass, carbon or aramid fibers, or of basalt fibers, while the thermosetting or thermoplastic material can be an epoxide or phenolic resin, but also a vinyl ester resin.

It should be noted that an additive may advantageously be added to the resin to confer a higher performance to the molded part. In particular, carbon nanotubes have the property of creating microscopic links between the carbon fibers, which reinforces the cohesion of the material permitting the fibers to have a clearly better macroscopic mechanical strength. This additive can be incorporated into the resin during its formulation, or during its phase of mixing with the fibers.

The fibers may have different lengths, the length being chosen or not according to the type of the part to be manufactured.

On the other hand, the proportion of fibers and thermosetting or thermoplastic material may also vary, and it is as well possible to mix fibers of different types as well as different thermosetting or thermoplastic material.

Furthermore, the dough 2 can be formed in two ways, according to the first one, the fibers are mixed, then the thermosetting or thermoplastic material is incorporated and, according to the second one, the fibers are pre-impregnated with thermosetting or thermoplastic material before being mixed. It is also possible to amalgam pre-impregnated fibers and thermosetting or thermoplastic material.

It is also possible to previously fill the mold 1 with dry fibers and afterwards to incorporate the resin.

According to the invention, the dough 2 is made from a paste previously prepared under air vacuum and mechanically mixed, eventually after incorporation of a dissolvent permitting to make the mixture more fluid, thus facilitating the mixing.

After preparation of the dough 2, the latter is inserted into the cavity 11 of the mold 1 through the well 12 into which the plunger piston 13 is then inserted, then a determined pressure F is exerted on the plunger piston 13, for example under the action of a press.

According to a variant, a thermal cycle is associated to the manufacturing cycle, the material the dough 2 is made of can thus be subjected to particular temperature conditions, during the preparation of the dough 2, during the putting under pressure, in such case, the mold 1 is configured to this end, or after the putting under pressure.

During the putting under pressure, the dough 2 adopts the shape of the cavity 11. It should be noted that in the embodiment shown the end 14 of the plunger piston 13, on the inner side, is shaped so as to participate in the forming of the part P to be manufactured.

It should be noted that prior to the insertion of the dough 2 into the mold 1, one or several braids and/or one or several layers of composite material can be inserted, in order to confer to the object additional strength in a particular direction or plane.

For example, the pre-positioning of a fabric in a dough or in the mold can occur so that it forms the skin of the part, and can be formed of fiberglass. This skin of fiberglass will have the advantage of forming a separation layer between the basic material of the dough and the external environment. The outer skin of the part can indeed be in contact with a surface having a galvanic torque with carbon, as is the case for aluminum. In such case, this separation layer is absolutely necessary and is treated by externally adding an insulation layer such as fiberglass.

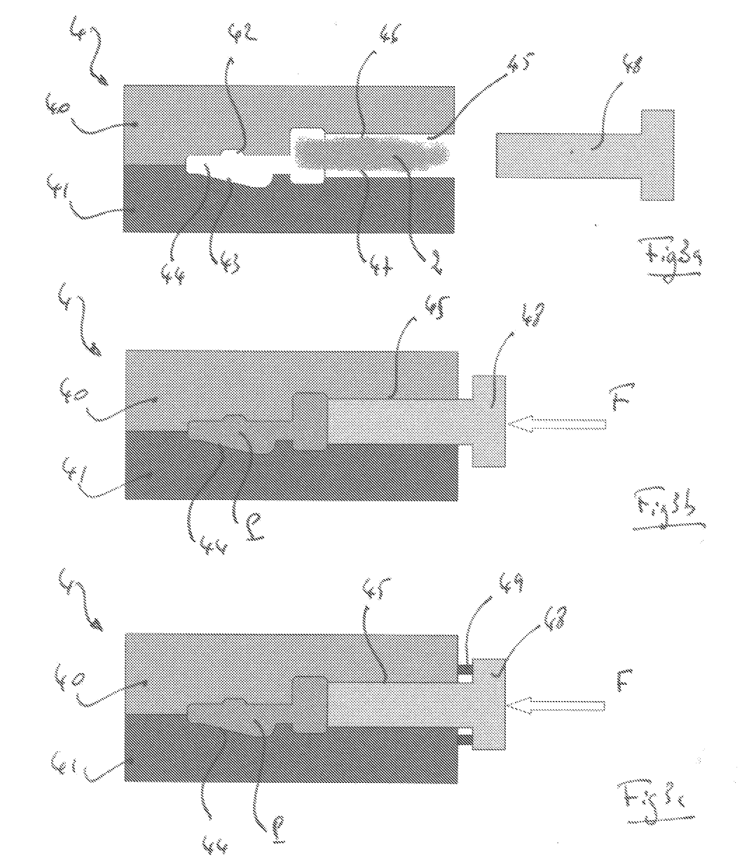

When referring now to FIGS. 2a, 2b and 2c, one can see a mold 3 according to another embodiment. This mold 3 is obtained by assembling two elements 30 and 31, each comprising a cavity 32 and 33, respectively, and the closure of which permits to form a molding cavity 34. In this embodiment, the element 30 is perforated with a well 35 that ends in the molding cavity 34, and in which can tightly slide a plunger piston 36.

In FIG. 2a, a dough 2 is inserted into the cavity 34 through the well 35, before the plunger piston 36 is inserted into same. In FIG. 2b, a pressure F is exerted onto the plunger piston 36 in order to put the dough 2 under pressure and to ensure its forming.

The quantity of material contained in the dough 2 should preferably be object of a fine weighing, in order to guarantee the shape of the part P.

In order to avoid such a fine weighing, it can be foreseen to insert into the dough 2 one or several compressible elements, for example a silicone ball or a closed-cell foam element, which is more or less compressed depending on the quantity of material contained in the dough 2, but which permits to guarantee the shape of the part P. It should be noted that one should preferably take care to arrange the compressible element or elements at locations not subjected to a particular resistance.

According to a variant, in case of uncertainty as to the quantity of material, an excess of material can be foreseen, which becomes an excess 20 that, as can be seen in FIG. 2c, positions itself in the well 35 at the end of the plunger piston 36, and that will either be maintained on the part P as non-functional or removed through machining.

When referring now to FIGS. 3a, 3b and 3c, one can see a mold device 4 according to the invention, in another variant. This mold 4 is formed by the closure of two elements 40 and 41, each comprising a cavity 42 and 43, respectively, and the closure of which permits to create a molding cavity 44. The mold 4 also comprises a well 45 ending in the molding cavity 44 and formed by the closure of two bores 46 and 47, each provided for in one of the two elements 40 and 41, respectively. The well 45 is aimed at receiving a plunger piston 48 capable, under the action of a pressure F, of putting a dough 2 under pressure for its forming in the molding cavity 44.

In FIG. 3c, one can see that thrusts 49 can be intercalated between the mold 4 and the plunger piston 48 in order to limit the penetration of the latter into the well 45, so as to guarantee the shape of the part to be molded P.

Irrespective of the embodiment of the mold device according to the invention, the pressure is used for forming the part P via the plunger piston, does not remain in the mold, which sees its internal pressure dropping because of the material flowing into the gaps of the mold and eventually into vents provided for to this end, so that in the dough can be foreseen thermosetting or thermoplastic material in excess.

Irrespective of the embodiment of the mold device according to the invention, the latter can include vents or a similar system permitting degassing the material during the molding operation.

1. Method for compression molding of composite materials comprising the steps of:
forming under pressure a dough comprised of an amalgam of non-woven fibers, randomly mixed and associated, according to a determined proportion, with a thermosetting or thermoplastic material;
preparing said dough being comprised of mixing said fibers and said thermosetting or thermoplastic material under air vacuum, wherein the forming is achieved by inserting said dough into a mold shaped and dimensioned so as to withstand high pressures, and which has a molding cavity having the shape of the part to be made and provided with at least one well configured so as to tightly receive a plunger piston the sliding of which is capable of bringing about the putting under pressure of said dough in said cavity; and
forming the cavity in said mold.

2. Molding method according to claim 1, wherein during the preparation of the dough, fibers are placed under air vacuum, then the resin is incorporated therein using the suction effect created by the air vacuum.

3. Molding method according to claim 1, wherein the fibers and the thermosetting or thermoplastic material are mixed, after having previously incorporated a volatile dissolvent.

4. Molding method according to claim 1, wherein the fibers and the thermosetting or thermoplastic material are mixed while complying with the following rules: the ratio between the length, or the minimum characteristic thickness, of the part to be manufactured, and the maximum length of the fibers is higher than 2, preferably equal to 4, and the ratio between the minimum length of the fibers and the diameter of the fibers is higher than 10.

5. Molding method according to claim 1, wherein, when the mold comprises several wells and plunger pistons, said plunger pistons being activated simultaneously or separately according to a particular time sequence.

6. Molding method according to claim 1, wherein the material is subjected, before, during and/or after the putting under pressure, to particular temperature conditions.

7. Molding method according to claim 1, wherein a force is applied to the plunger piston or pistons, so as to generate a pressure between 30 and 1000 bars, according to needs.

8. Molding method according to claim 1, wherein fibers having a length that can vary in a controlled or random way between 0.1 and 100 mm are used for forming the dough.

9. Molding method according to claim 1, wherein prior to the insertion of the dough, one or several layers of woven or non-woven web of reinforcing fibers embedded in a thermosetting or thermoplastic matrix are placed in the molding cavity of the mold.

10. Molding method according to claim 1, wherein one or several inserts are incorporated into the dough, aimed at remaining in the part to be made, this incorporation occurring either during the preparation of said dough or after the insertion of said dough into the mold, or during the insertion into said mold, said insert or inserts having previously been positioned in the latter.

11. Molding method according to claim 1, wherein the insert or inserts comprise one or several metallic or plastic elements, or of one or several composite elements being in the form of a braid and/or a web or a layer of composite material.

12. Molding method according to claim 1, wherein the materials entering into the composition of the dough are finely weighed, so as to guarantee the shape of the part to be molded.

13. Molding method according to claim 1, wherein more thermosetting or thermoplastic material than necessary is incorporated into the dough, and wherein the flow and evacuation of the excess of said material is foreseen.

14. Molding method according to claim 1, wherein at least one element comprised of compressible material is incorporated into the dough.

15. Mold device for implementing the molding method according to claim 1, said mold device comprising:
one element or several assembled elements having internally a cavity having the shape of the part to be made, said cavity being comprised of at least one well permitting the loading of the mold with material to be molded and slideably receiving, tightly, a plunger piston, said plunger piston sliding generated by driving means is capable of bringing about the putting under pressure of said material to be molded.

16. Mold device according to claim 15, wherein the plunger piston comprises, on the inner side of the mold, an end shaped so as to participate in the forming of the part to be molded.
